(19) United States
(12) Patent Application Publication
(10) Pub. No.: US 2015/0100396 A1
(43) Pub. Date: Apr. 9, 2015

(54) Integrated Incentive Network System and Method

(71) Applicant: Hani Boury, Dallas, TX (US)

(72) Inventor: Hani Boury, Dallas, TX (US)

(21) Appl. No.: 14/323,285

(22) Filed: Jul. 3, 2014

Related U.S. Application Data
(60) Provisional application No. 61/887,023, filed on Oct. 4, 2013.

(51) Int. Cl. G06Q 30/02

(52) U.S. Cl. CPC G06Q 30/0229
USPC 705/14.3

(57) ABSTRACT

Disclosed herein is an Integrated Incentive Network incentivizes traffic to merchant storefronts by tying member merchants and member users into an integrated incentive network that incentivizes member users to become repeat visitors to member merchant sites through the use of network points. Such points not only may be earned at any member merchant site, but may also be redeemed at any member merchant site. Member merchants may additionally offer their own unique points redeemable only at their sites in order to increase repeat business. Also, network points may be redeemable at a higher value/discount when redeemed at the same member merchant site at which they were earned. The pricing of network points may also be different for one member merchant as compared to another such that the redemption value at one merchant may be different than at the other. While the disclosed Integrated Incentive Network is private with regard to member users and member merchants, it may be implemented using a public communications network, such as the Internet.

### PRIORITY CLAIM

The present disclosure is a non-provisional conversion of, and thus claims priority to, U.S. Provisional Patent Application Ser. No. 61/887,023, filed Oct. 4, 2013, the entirety of which is incorporated herein by reference for all purposes.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### TECHNICAL FIELD

The disclosed principles relate generally to incentive-based networks, and more particularly to an integrated incentive network system and related method for providing incentives for consumers to patronize merchant internet/online storefronts and websites.

### BACKGROUND

In the conventional Internet-based search engine advertising models, using Google®, Bing®, Yahoo!® (inventor acknowledges that any reference to any trademarks in this disclosure is for exemplary purposes only, and such marks are and remain the exclusive property of the owner(s) of said marks), and other search engines and other display networks to find a desired product service, and/or content, merchant advertisers are typically charged after a pre-determined number of advertisements for their site, goods, or services are displayed to a searcher (known as “impressions”), as well as if the searcher clicks-through a displayed advertisement to the merchant's website. In addition, because the conventional model acts as a gateway to advertising merchants' websites, conversions (i.e., actual purchases made as a result of the click through advertisement) are typically quite low in comparison to the number of impressions.

FIG. 1 illustrates an example of the conventional “funnel effect” of the conventional Internet-based search engine based advertising models provided by the Google® search engine, well as the Display Network-based advertising model, as just a single example of the inefficiency of the conventional advertising models. The conventional advertising models yield on average less than 1% (0.82%) click-through rate through search engines and display networks. In the illustrated model, the search engine is the largest profiteer since they are paid on impressions displayed on search results pages shown to searching consumers, as well as click-throughs that do not even lead to conversions. On the flip side of the same coin, the merchant advertisers fund the search engines but obtain very little benefit for their spent advertising dollars.

Accordingly, what is needed in the art is a new approach to incentivize consumers to visit, and make purchases from, a merchant's storefront, such as an Internet website, as well as to incentivize merchants to reward repeat visitors and repeat purchasers at their storefronts. Moreover, what is needed is an incentivizing technique that employs the earning and redeeming of reward points as an method of monetization for advertising merchants. The disclosed principles provide such solutions, as discussed in detail below.

### SUMMARY

Disclosed herein is an Integrated Incentive Network system and related method, which may be implemented using a data or communications network, such as the Internet or any other computer or communications network, and that incentivizes network traffic by tying member merchants & member users/subscribers into an integrated incentive network that promotes member users to become frequent repeat visitors to member merchant sites through the use of network points (i.e., “iPerk points”). Such points not only may be earned at any member merchant site, but may also be redeemed at any member merchant site. In some embodiments, member merchants may additionally offer their own unique points redeemable only at their sites in order to increase repeat business. In other embodiments, network points may be redeemable at a higher value when redeemed at the same member merchant site at which they were originally earned, versus other member merchants' sites. In yet other embodiments, the pricing of network points can be different for one member merchant as compared to another member merchant such that the redemption value at one merchant may be different than at another merchant. While the disclosed Integrated Incentive Network is private with regard to the member users and member merchants, it may be implemented using a public data or communications network, such as the Internet. Moreover, the disclosed integrated inventive network may be implemented via mobile applications, such as through mobile versions of member merchant websites, as well as mobile application interfaces for users and/or merchants to access the incentive network. Those who are skilled in the art will understand the means by which member security and privacy within the disclosed Integrated Incentive Network may be maintained.

In one aspect, private integrated incentive networks are disclosed herein for providing incentives for registered member users of the network to patronize sites of registered member merchants of the network. In one embodiment, such an exemplary integrated incentive network may comprise a central network controller configured to track individual member user activity on any member merchant site. Such a network may also comprise a user interface in communication with the central network controller, and configured to permit member users access to the central network controller, as well as a merchant interface in communication with the central incentive network, and configured to permit member merchants access to the central incentive network. In some embodiments, the tracking may be provided by an application program interface (API) or other similar technology, either now existing or later developed, embedded in one or more components of such a system, and configured by the central controller. In exemplary embodiments, the central network controller is further configured to award network points to a member user based on said member user visiting any member merchant site, and to facilitate redeeming by a member user of earned network points for value at any member merchant site. Such a network may further comprise a repository in communication with each of the central network controller, the user interface, and the merchant interface, the repository configured to store member user profile information and member merchant profile information, and further configured to store information regarding network points earned and redeemed by member users.

In another aspect, method are disclosed herein for providing incentives for registered member users of a private integrated incentive network to patronize sites of registered member merchants of the network. In one embodiment, such an exemplary method may comprise storing member user profile information and member merchant profile information. Such a method may further comprise tracking individual member user activity on any member merchant site, and awarding network points to a member user based on said member user visiting any member merchant site. Such methods may also comprise storing information regarding network points earned by member users, facilitating redeeming by a member user of earned network points for value at any member merchant site, and storing information regarding network points redeemed by member users. Other exemplary networks and related methods in accordance with the disclosed principles are also disclosed herein.

### BRIEF DESCRIPTION OF THE DRAWINGS

FIG. 1 illustrates an example of the conventional “funnel effect” of the conventional Internet-based search engine based advertising models provided by the Google® search engine, as well as the Display Network-based advertising model.

FIG. 2 illustrates a conceptual diagram of the Integrated Incentive Network of the disclosed principles of tying member users and member merchants together in a single mutually beneficial relationship.

FIG. 3 illustrates a high-level block diagram of one embodiment of an Integrated Incentive Network and implemented in accordance with the disclosed principles.

FIG. 4 illustrates a block diagram of the interaction between the application programming interface and the member users in accordance with the disclosed principles.

FIG. 5 illustrates a block diagram of one embodiment of the interaction between the member users, the front end network website, and subsequently the repository in accordance with the disclosed principles.

FIG. 6 illustrates an exemplary embodiment of a screen shot of a computer network site, such as an Internet website, that may facilitate the front end network website.

FIG. 7 illustrates a block diagram of one embodiment of the Integrated Incentive Network that facilitates a Member User Account Maintenance and Incentive Exchange Platform.

FIG. 8 illustrates a block diagram of an embodiment of the Integrated Incentive Network that facilitates interaction between the member users and the member merchants' websites and repository by means of an API.

FIG. 9 illustrates an exemplary embodiment of a screen shot of a computer network site, such as an Internet website, that may facilitate the Integrated Incentive Network on a member merchant's website or online shopping cart.

FIG. 10 illustrates a block diagram of one embodiment of the interaction of the repository with member merchants, and in particular the member merchants' websites, as well as the means by which the member merchants conduct their advertising campaigns to member users.

FIG. 11 illustrates an exemplary embodiment of a screen shot of a computer network site, such as an Internet website, that illustrates the disclosed principles in the context of electronic advertisements.

FIG. 12 is an exemplary embodiment of a screen shot of electronic mail that illustrates the disclosed principles in the context of an email.

FIG. 13 is a block diagram of an embodiment of the Integrated Incentive Network that involves facilitating the member merchants' interaction with the Integrated Incentive Network.

FIG. 14 sets forth a flow diagram of exemplary embodiments for earning and redeeming network points in an Integrated Incentive Network as disclosed herein.

### DETAILED DESCRIPTION

An Integrated Incentive Network constructed and implemented in accordance with the disclosed principles (which may be also be called the “iPerk™ Network”) provides a loyalty-based incentive network that brings together consumers and merchants in a mutually beneficial online network that rewards consumers via discounts, rewards, and other incentives, while reducing marketing and other merchant costs and increasing merchant site or other storefront visibility by enhancing click-through rates. Notably, as discussed further below, the click-throughs under the disclosed principles are not through “gateway” sites, such as impressions presented on a search engine or the like, and instead such click-throughs may be through distributed merchants' assets like the merchants' own website(s) and merchants' distributed advertisements, e.g., through email campaigns, as well as posted on social network or other non-merchant sites. By equitably redistributing the benefits and reducing the middle tier in the conventional search engine model, display network, and other conventional models, member merchants of the Integrated Incentive Network can directly engage and reward member users of the Integrated Incentive Network for their consideration and for their repeated loyalty.

The disclosed Integrated Incentive Network exchanges consumer site “walk through” (i.e., visits to member merchant websites by member users) for network points. In one embodiment, member users receive network points for visiting the member merchants' websites and may earn more points based on “session quality, depth, walking through” the websites and viewing products, services, or content offered by the member merchant. Moreover, “conversion” created by member users' purchases at the member merchant's storefront or website may also earn network points.

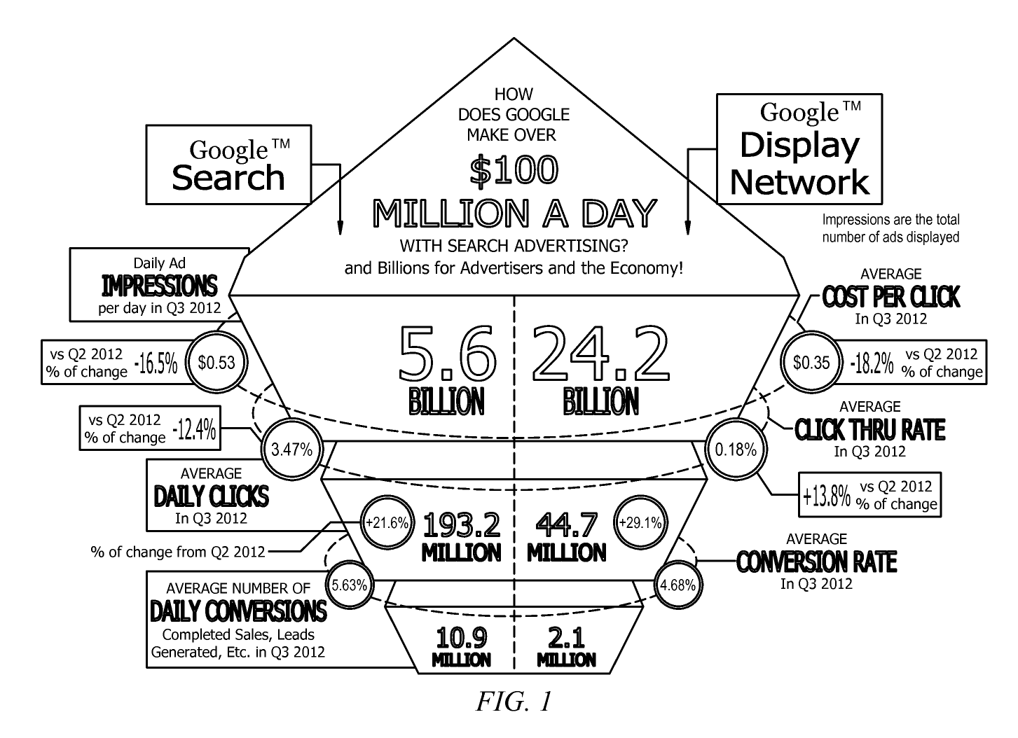

By implementing the unique approach of the disclosed Integrated Incentive Network, merchants can reshape the benefit structure currently provided by traditional Internet advertisement campaign models. Accordingly, the disclosed Integrated Incentive Network aims directly at “click-through” traffic while bypassing “impressions.” Consequently impressions are reduced while click-throughs are simultaneously increased, which is contrary to the conventional search engine-based models currently employed. Moreover, as discussed above, the disclosed principles do not involved the use of “gateway” sites, such as first navigating to a search engine, and then click-through the search results or advertisement impressions on that site in order to navigate to a merchant's site. Not only is the conventional use of first navigating to gateway sites a hassle to consumers, but such a model is more costly to merchants since they pay for impressions that so often does not results in a click-through, much less a converted sale (i.e., see FIG. 1 above). In contrast, a system or method in accordance with the disclosed principles provides the benefits disclosed herein without the need for gateway or other similar sites. Such benefits are provided through the integration of an incentive network using tracking mechanisms, for example, application program interfaces (APIs), embedded in advertisements or sites that track member user activity within the Incentive Network and communicate such network activity back to the Network. Details of such tracking to create integrations in the disclosed Incentive Network are provided below.

A non-exhaustive list of benefits to member users and member merchants of an effective Integrated Incentive Network in accordance to the disclosed principles include:
Increased recurring visits to member merchant websites and storefronts
Increased conversion rate through the Integrated Incentive Network rewards points
Better cost structure—when a sale happens, member merchants avoid paying based on impressions in favor of the provided “pay for performance” model
Increased advertising campaign effectiveness by improving click-through rates
Merchant loyalty—member users become loyal to member merchants versus non-member merchants
Improved page depth and session quality
Application over conventional websites or mobile device applications

In contrast to the conventional search engine-based and display models, such as the example in FIG. 1, with the disclosed private, member-based Integrated Incentive Network, merchants are not paying for advertisements that are displayed to just any searcher, regardless if their potential interest in the merchant's goods or services has been established. Accordingly, the disclosed principles allow member merchants of the Integrated Incentive Network to directly target consumers that are part of the same Integrated Incentive Network, and thus may be previous customers or those potential customers that have an interest in the member merchant's goods or services. Such an approach allows member merchants to focus their advertising dollars towards methods that are more likely to attract users to visit the member merchants' website. This ultimately results in a more efficient use of advertising dollars. Moreover, conventional approaches do not account for, or more importantly, reward, consumer loyalty simply for repeat visits to, in addition to rewarding for purchases made from, a merchant's website or other storefront.

Furthermore, in a system or method in accordance with the disclosed principles, merchants are in a pay-per-sale fee structure, as compared to the conventional pay-per-impression or pay-per-click-through models, where the fees are based on the number of inventive network points redeemed towards a discount. Initially, member merchants may only be charged a fee by the Incentive Network when a conversion (sale) occurs. Moreover, the pay-per-sale model of the disclosed principles may be based on the use of (redemption) of network points at a that member merchant's site or other asset. Furthermore, member merchants of the Network may be incentivized to charge less reward points for discounts provided to member user, and conversely for providing greater discounts per redeemed reward points. Specifically, a system or method of the disclosed principles can include a progressive fee/pricing structure for merchants that decreases as that value given for redeemed network points is increased. For example, if a merchant provides a 10% discount off of a purchase in exchange for the member user redeeming 100 network points, the cost per transaction payable to the Incentive Network may be greater than if the member merchant provided a 15% discount for the same number of network points redeemed by the user. With this unique pricing mechanism for network points, not only are member merchants incentivized to provide greater discounts (by lowering their price-per-purchase), but members are incentivized to make larger or more purchases from member merchant assets due to increased discounts, which translates to increased value to both member users and member merchants.

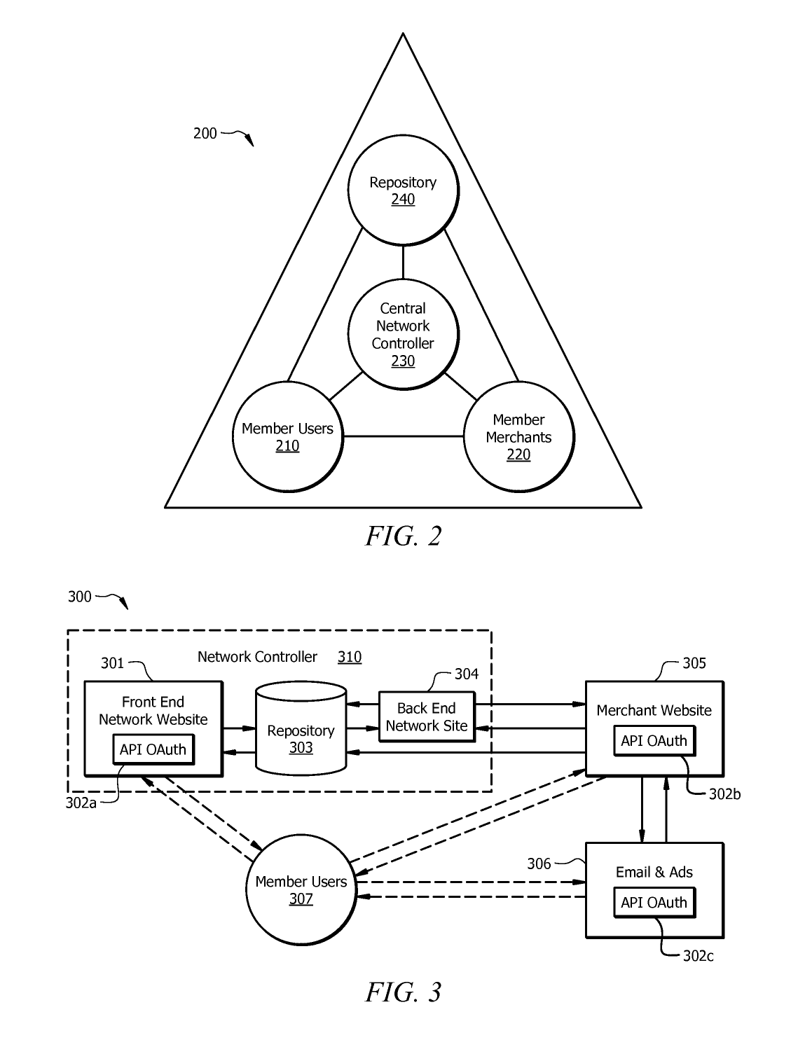

FIG. 2 illustrates a conceptual diagram 200 of the Integrated Incentive Network of the disclosed principles of tying member users and member merchants together in a single mutually beneficial relationship via an integrated incentive network as disclosed herein. Generally speaking, the disclosed principles exemplified in the conceptual diagram 200 show the relationship between all the components of an integrated incentive network in accordance with the disclosed principles: member users 210, member merchants 220, a central network controller 230, and a repository 240. The central network controller 230 acts as the central focus point of the Incentive Network 200 that brings the member users 210, member merchants 220, and the repository 240 together. For example, the central network controller 230 may comprise an API or other similar technology that assists in integrating the other components of the systems, for example by being embedded in interfaces employed by members and merchants, and by being in communication with the repository 240. Intercommunication between one or more of these components may be provided via a public communications network, such as the Internet. Moreover, intercommunication may be implemented via mobile devices, e.g., mobile applications or mobile browser plug-ins.

In one embodiment, the relationship between all the components of the conceptual diagram 200 may be expressed through an integrated or common point system. With the disclosed Integrated Incentive Network 200, member user loyalty to member merchants may be rewarded with “network points” (sometimes referred to as an “iPerk™” or “iPerk Points™”). In one embodiment, member merchants 220 may be able to establish their own method of allocating network points and discounts for such points. Moreover, the central network controller 230 may propagate the member merchants' allocation of network points to the member users 210 and to the repository 240. Examples of such point propagation are discussed in detail below. In one embodiment, member users 210 may visit storefronts of member merchants 220, and the member merchants 220 in turn would access both the central network controller 230 and repository 240 to get information about the member users 210 and about the member merchants' 220 own settings disclosed to the Integrated Incentive Network 200 and stored in the repository 240.

The conceptual diagram in FIG. 2 demonstrates various paths of embodiments of the disclosed principles, many of which are discussed below in additional detail. Collectively, the integration with an Incentive Network and related methods provided in accordance with the disclosed principles is provided by the “universal” network points earned and redeemed at any member merchant asset, such as a merchant website, catalogue, or other mechanism by which sales by merchants may be provided to member consumers. The use of such universal network points creates the Incentive Network by joining otherwise unrelated merchants and consumers together into a mutually beneficial private network. APIs or other similar technology facilitates the communications for such an integrated network, whether they be express communications between member users or member merchants with the central controller 230, or they are underlying communications by the network to identify, authorize and otherwise facilitate earning and redeeming of network points, as well as charge and collect pay-per-purchase fees for converted sales among integrated members of the network. Moreover, the ability to incentivize member merchants to increase their discounts/rewards (as opposed to decreasing discounts as found in the conventional advertising and rewards-based models in order to recoup on the costs of unsuccessful advertising), which in turn incentivizes member consumers to patronize member merchant assets over non-member merchant assets, further provides the integration of an Incentive Network in accordance with the disclosed principles. In sum, the integration provided by the disclosed principles is something not found in conventional advertising models in that costs to both member merchants and consumers are effectively decreased as the integration among these network participants increases. In conventional models, merchants actually spend more per-transaction when they increase discounts to consumers in order to increase the volume (and thus the values) of transactions, while with the disclosed principles, merchants actually spend less per transaction as they increase offered discounts or other rewards. Accordingly, not only are the network participants rewarded for participating in the network, the costs-per-conversion to both merchants and consumers actually decreases as their participation (through increased discounts by merchants, which results in increased purchases by consumers) increases.

FIG. 3 illustrates a high-level block diagram of one embodiment of an Integrated Incentive Network 300 constructed and implemented in accordance with the disclosed principles. The Incentive Network 300 may be implemented via a front end network website 301, a repository 303, and a back end network site 304. In FIG. 3, as well as other figures discussed herein, a central network controller 310, whether implemented in a single component or multiple components, may comprise the front end network website 301 and/or the back end network site 304, for example, via one or more servers hosting either or both sites 301, 304. In some embodiments, the central network controller 310 may also comprise the repository 303. In other embodiments, one or more of the front end network website 301, the back end network site 304, and the repository 303 may be embodied in a different component(s) in communication with the central network controller 310. Also, the front end network website 301 and/or the back end network site 304 may be implemented via mobile applications. Moreover, the central network controller 310 may comprise one or more of processors, data stores, memory, and other similar components, as needed to implement an Incentive Network in accordance with the disclosed principles.

In one embodiment, the disclosed Integrated Incentive Network 300 may be powered by an application programming interface (API) (302a, 302b, 302c; collectively 302) embedded in front end network websites 301, member merchant websites 305 or other similar consumer interfaces, as well as email and other electronic advertisements 306, such as banner ads and the like. The API 302 may use an authorization mechanism for member users 307 to access the Integrated Incentive Network 300. The API 302 seamlessly interacts with the front end network website 301, the member merchant websites 305, and email and other electronic advertisements 306. This seamless interaction permits member users 307 to interact within the Incentive Network 300 via these interfaces. The API 302 may also interact with the repository 303 or similar database storage system, as needed.

The repository 303 may comprise one or more data stores within a communications network. These data stores may be located together, or they may be distributed in various geographic locations. In either embodiment, the Incentive Network 300 maintains the repository 303 for storage and retrieval of a host of network information. For example, the repository 303 may act as a depository and redemption system of network points that are deposited by member merchants and redeemed by member users 307 by exchanging network points for discounts or other incentives that may be created by the member merchants or the Integrated Incentive Network. Thus, the repository 303 accounts and maintains network points and incentives for member users 307 and member merchants.

In some embodiments, the repository 303 may be used to store profiles and account information of member users 307. If multiple data stores are employed for the repository 303, such profile and/or account information may be stored separately from the stored network points discussed above. Member users 307 may be able to access their profiles and account information stored in the repository 303 through the front end network website 301 or perhaps even through member merchant websites 305. The repository 303 may also be used to store member merchants' profiles and account information. Member merchants' profiles and information may include products or services that the member merchants offer and that may be redeemed through network points. It may also include information on how member users 307 may earn network points. The repository 303 may also include information about redemption of network points for member merchants' products or services, as well as Network metrics, Member User metrics, Merchant Member metrics, User and Member account maintenance information, ads used in the Incentive Network, as well as means of ad distribution, such as via email, etc.

The repository 303 may also store network rewards points earned by member users 307, as mentioned above. Network points may be associated with specific member merchants at which the member users 307 earned the points or even redeemed. In such association between network points and member merchants, the Integrated Incentive Network 300 may provide marketing information to member users 307 about their consumer habits. Member users 307 may be able to redeem network points at a higher value with the member merchant associated with those network points, as compared to other member merchants of the Incentive Network 300.

The back end network site 304 may provide access and interaction between the repository 303 and the member merchants' websites 305. In exemplary embodiments, the back end network site 304 may be used by member merchants to access the repository 303 to provide information and data to the member merchants' websites 305, and vice versa. Typically, the back end network site 304 may be employed by member merchants to access information in the repository 303 in a similar manner that member users 307 access information in the Integrated Incentive Network via the front end network website 301. Of course, other uses for either the front end network website 301 and the back end network site 304 may also be provided in accordance with the disclosed principles.

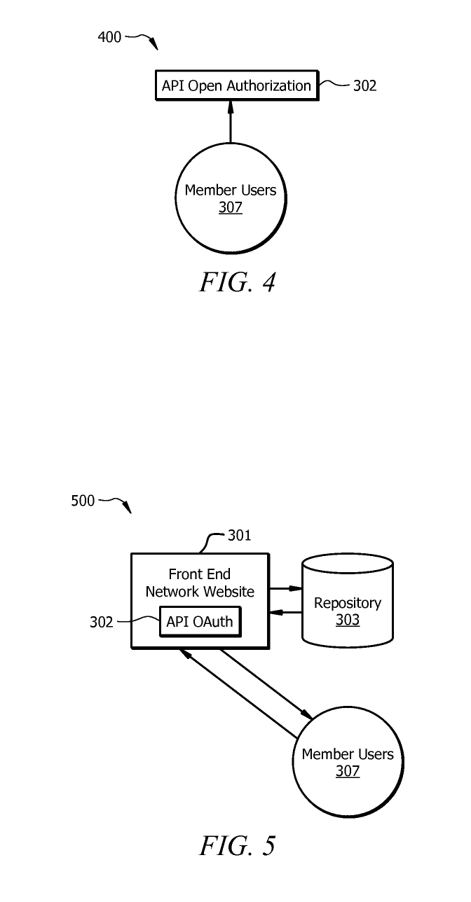

FIG. 4 illustrates a block diagram 400 of one embodiment of the interaction between an API, such as the API 302 illustrated in FIG. 3, and the member users 307 in an exemplary Integrated Incentive Network in accordance with the disclosed principles. The API 302 may use open authorization (“OAuth”) as an authorization mechanism for member users 307 to securely access and send information in the Integrated Incentive Network. In alternative embodiments, instead of OAuth, the API 302 may use OpenID as an authorization mechanism. Of course, any type of authorization or authentication mechanism may be implemented in accordance with the disclosed principles.

In one embodiment, the API 302 may be configured through an authorization mechanism to recognize when the consumer is a member user 307. This may be accomplished via a specific login for the member user 307, or it may be accomplished automatically when the member user is recognized (e.g., via a cookie on the user's computer or other technique). Moreover, such recognition may occur whether the member user 307 is employing the front end network website 301 or is visiting a member merchant's website 305. The API 302 may also determine upon some authentication mechanism identifying the specific member user how many, if any, network points the member user 307 may have. This type of interaction may be included whenever the member user 307 interfaces with a facet of the Integrated Incentive Network. The API 302 may also facilitate the member merchants' access and interaction with the Integrated Incentive Network, as discussed in further detail below.

FIG. 5 illustrates a block diagram 500 of one embodiment of the interaction between the member users 307 and the front end network website 301, as well as the repository 303. Member users 307 may access the Integrated Incentive Network via a front end network website 301 created to interface member users 307 with the Integrated Incentive Network. In one embodiment, new members may use the front end network website 301 to create a new account or to join the Integrated Incentive Network. In other embodiments, member users 307 may access their existing account information to monitor their current network point balances, as well as prior and current reward redemptions. Member users 307 may also monitor their account history, such as member merchants' websites they have visited, time spent on such websites, and their consumer history. In another embodiment, member users 307 may adjust their account preferences and how the Integrated Incentive Network, the repository 303, and the member merchants' websites apply the network points earned by the member users 307 to products or services. Other interactions between member users 307 and the front end network website 301 implemented to maintain the disclosed Integrated Incentive Network may also be provided to member users 307.

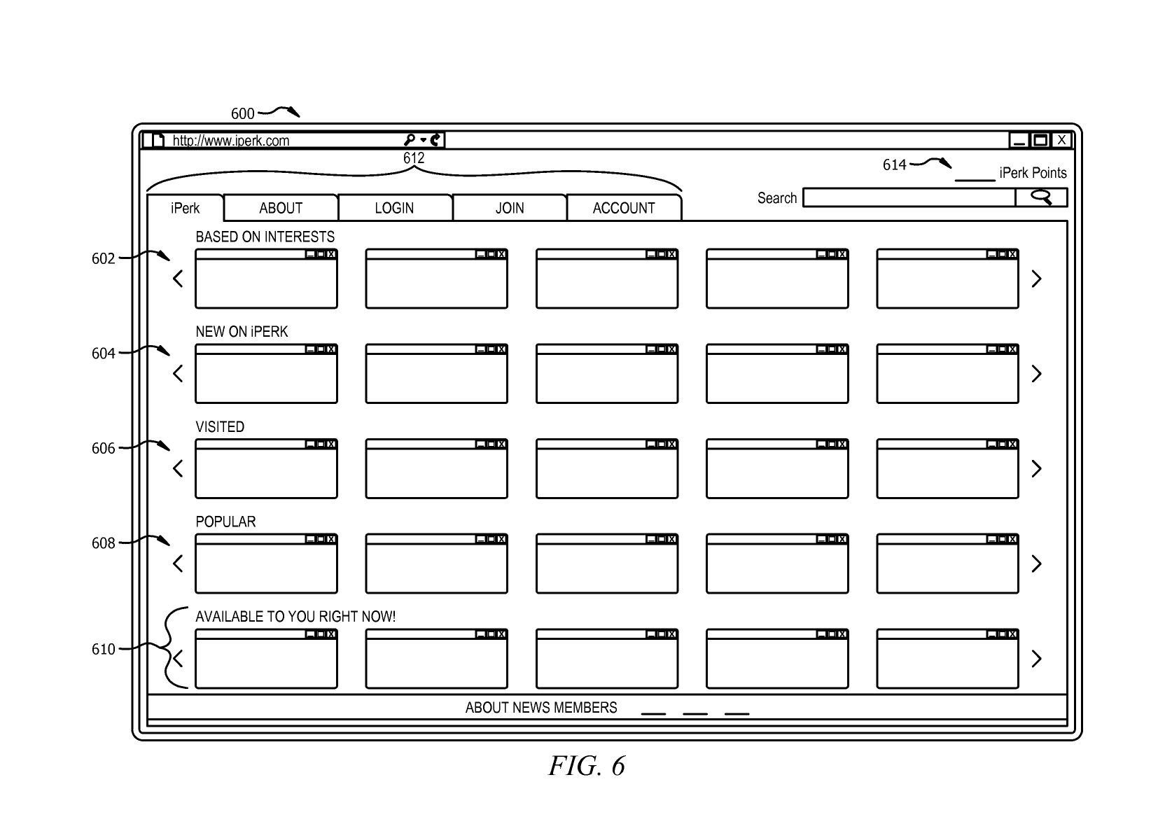

FIG. 6 illustrates an exemplary embodiment of a screen shot 600 of a computer network site, such as an Internet website, that may facilitate a front end network website, such as the website 301 discussed above with respect to FIG. 5. In one embodiment, the front end network website 301 may consolidate member merchants' products or services, or even the member merchants themselves based on some categorical similarity between merchants. It may display products or services offered by member merchants on a single page, or on pages that reflect the product or services' respective categorical classification.

The Integrated Incentive Network may provide through the front end network website 301 a portal to all of the member merchants that participate in the Integrated Incentive Network. When used as a portal to member merchants' websites, the front end network website 301 may categorize the member merchants based on the member user's history or preferences, and display the member merchants' logo based these categories. The screenshot 600 displays multiple member merchant sites divided in several various categories that may be shown to a member user on a front end network website 301 once the user accesses the Network. These categories (602, 604, 606, 608, 610) may also be displayed on individual pages for each category. The front end network website 301 may include a category based on a member user's interests 602, for example, member merchant sites may be displayed as possibly of interest to the member user based on the member user's prior activity on the Incentive Network. Alternatively, these suggested sites may be based on the member user's current network point balance or which merchant sites currently are offering increased redemption rewards. There may also be a category 604 of sites of member merchants that are new to the Integrated Incentive Network, a category 606 displaying member merchants' sites visited by the member users, or a popular category 608 of member merchants' sites visited or frequented by many member users. Furthermore, there may also be a category 610 of member merchant sites or even specific goods, services or content, that may be available to the member user based on his current network point total. These could be items available through member merchant sites illustrated in this category 610, or they may be illustrations of items available for redemption directly from the Incentive Network. The front end network website 301 may contain any, all, or any combination of the categories listed above for member users' ease of use, as well as categories not illustrated in FIG. 6.

In other embodiments, the front end network website 301 may act as a forum for member users, where member users may discuss exchanges of points at their own behest. Member users may use the front end network website 301 for maintaining their account, viewing their browsing history, and setting up their user preferences. The screenshot 600 of the front end network website 301 shows navigation tabs 612 that a user (member or non-member) may utilize to access parts of the system disclosed herein. The screenshot 600 also displays an indicator 614 of a member user's network points. This indicator 614 may assist member users in keeping track of how many network points they have as they browse the front end network website 301. Of course, other information in accordance with the disclosed principles may also be provide on the exemplary screen shot 600 of the front end network website.

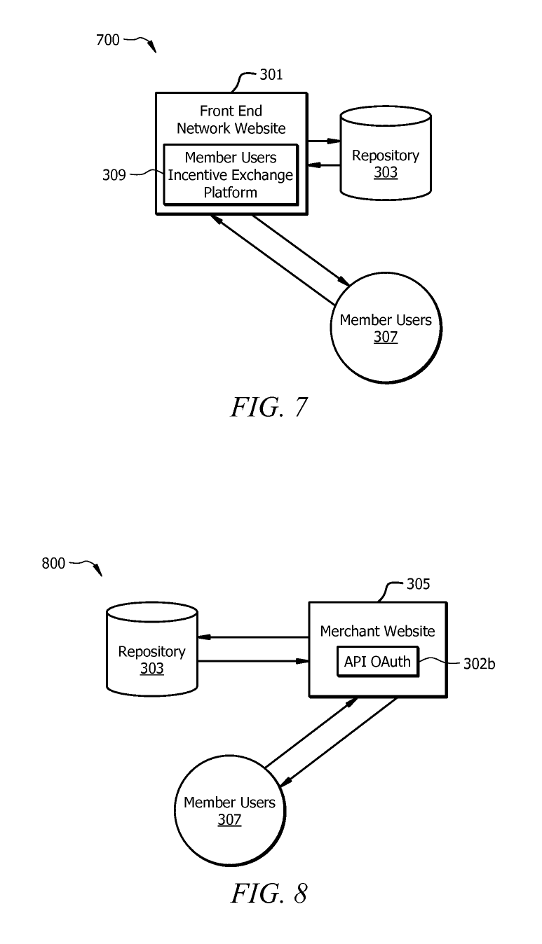

FIG. 7 illustrates a block diagram 700 of one embodiment of a portion of the Integrated Incentive Network that facilitates a Member User Account Maintenance and Incentive Exchange Platform. In one embodiment, the Member Users Incentive Exchange Platform 309 may be interfaced with the front end network site 301, and may be accessible by member users 307 who wish to participate in such an exchange. Through such a platform, member users 307 may be able to gift network points to other member users, or if member users wish to gift network points to non-member users, they may be able to send an invitation to join the Integrated Incentive Network that includes the gift of network points. Moreover, the exchange of network points may be with the Integrated Incentive Network itself. Additionally, member users 307 may exchange points with other member users 307. As discussed in further detail below, member merchants may disburse/award their own dedicated merchant points, and under a Member User Incentive Exchange Platform 309, member users 307 may exchange dedicated merchant points for more general network points (i.e., usable at all member merchant sites) through the Integrated Incentive Network directly.

In an exemplary embodiment, member merchants may provide points that are unique to their own products and services. Such unique merchant points may be in addition to, or in place of, universal network points that may be redeemable at any of the member merchant storefronts. In these embodiments, while member users may amass merchant points from certain member merchants, a Member User Incentive Exchange Platform 309 as disclosed herein may provide member users the opportunity to exchange some or all merchant points for network points or other merchant points from a different member merchant having goods or services the member user would rather have. As mentioned before, points may also be exchanged between users or to the Integrated Incentive Network itself, whether the points are network points or unique merchant points.

In one exemplary embodiment, the exchange values between points may not be equal. For example, merchant points from one member merchant may be deemed more desirable or more valuable, and thus an exchange for such merchant points may result in receiving a greater amount of value of other types of points from the Integrated Incentive Network or other member users. Additionally, member merchants may manually set difference exchange values between its merchant points and other types of points from the Integrated Incentive Network and other member merchants. Of course, other means of implementing an exchange program for earned points may also be provided in accordance with the disclosed principles.

FIG. 8 illustrates a block diagram 800 of an embodiment of a portion of the Integrated Incentive Network that facilitates interaction between the member users and the member merchants' website and a repository by means of an API s. When member users 307 access member merchants' websites 305, the API 302b embedded into the member merchants' websites 305 is employed to communicate with the repository 303 to provide and retrieve member users' information relevant to the respective member merchant. As member users 307 patronize member merchants' storefronts and websites 305, network points are earned by member users 307. In response to qualifying transactions between member users 307 and member merchants (and their websites 305), the repository 303 is configured to disburse, redeem, store, account for, and maintain network points, incentives and rewards for member users 307 and member merchants.

The member merchants' websites 305 may also communicate the member users' shopping habits to the Integrated Incentive Network. This can include communicating information on what the user browsed while at the merchant's website 305, what the user purchased, frequency of visits and purchases, and other habitual information. Based on such information, the member merchants' website 305 may display items that may appeal to the member users 307 based on user history or user preferences stored on the repository 303. Also, the member merchant may choose to reward the user with certain incentives derived from this type of stored information. Such rewards could include awarding additional network or unique merchant points, offering additional discounts for redemption of points, or other incentives useful and desirable to the member user 307.

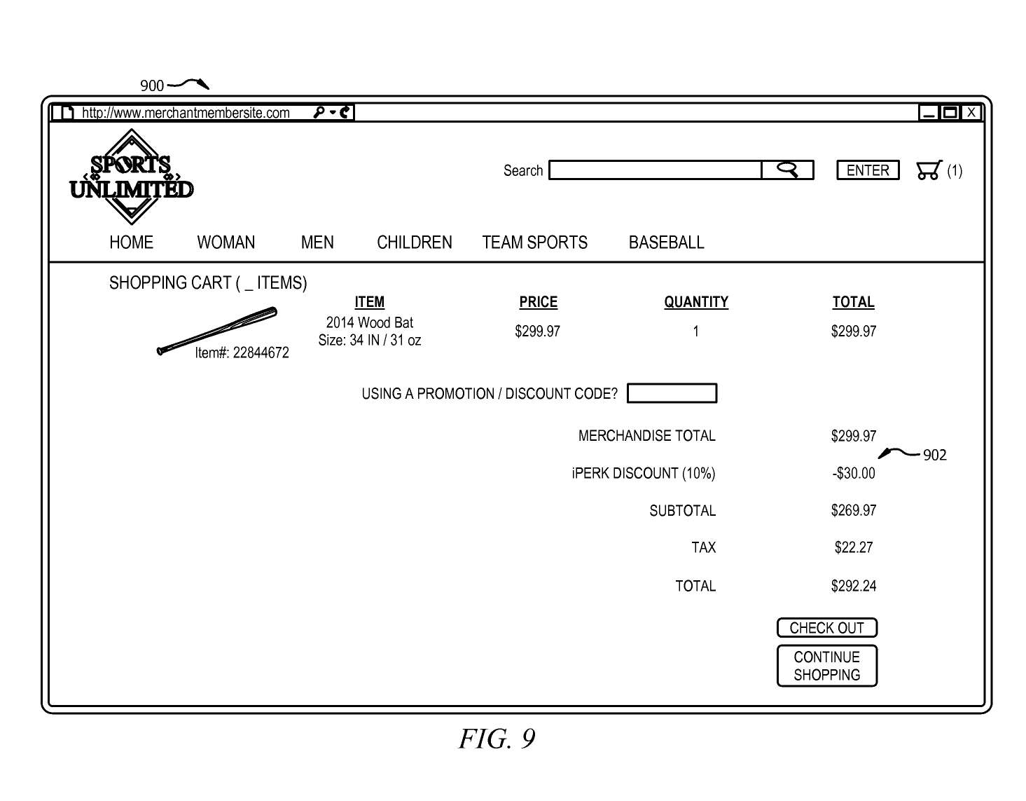

FIG. 9 illustrates an exemplary embodiment of a screen shot of a computer network site 900, such as an Internet website, that may facilitate the Integrated Incentive Network on a member merchant's website or online shopping cart. An API, as discussed above, may be employed to provide the integration between the illustrated website 900 and the disclosed Incentive Network.

In one embodiment, the member merchant's website 900 may indicate that member users of the Integrated Incentive Network may only redeem network points on a front end network website. In another embodiment, the member merchant's website 900 may allow member users to redeem their earned network points (or their unique merchant points as the case may be) directly on the member merchant website 900. The website 900 may also indicate the member users' network points on every webpage, once the user has been authenticated to the website 900 as member of the Incentive Network.

As illustrated, redemption of network points may be done by exchanging the deposited network points for rewards (e.g., discounts, which may be dollar amounts or percentage based) during checkout within the member merchant's checkout process. Discounts and rewards earned from member merchants and through the Integrated Incentive Network may be displayed as total discount/reward for all items for which network points are redeemable, as shown in FIG. 9. In more specific embodiments, the website 900 may display the actual discount 902 stemming from the redemption of the member users' network points in the website's shopping cart, as shown in FIG. 9. Such a discount may be provided by a specific dollar amount subtracted from the ongoing transaction, or it may be provided by a percentage of discount to be subtracted from the transaction. Of course, other types of discounts for redemption of network or unique merchant points may also be provided in accordance with the disclosed principles.

Moreover, since member merchants may only be charged a fee by the Incentive Network when a conversion (sale) occurs, the pay-per-sale model of the disclosed principles may be based on the illustrated redemption of network points at the member merchant's site 900. Furthermore, as discussed above, member merchants of the disclosed Incentive Network may be incentivized to charge less reward points for discounts provided to member user, and conversely for providing greater discounts per redeemed reward points. Specifically, such a progressive fee/pricing structure decreases costs per sale to the merchant as that value given for redeemed network points is increased. In the illustrated example, the merchant is providing a 10% discount off of the purchase in exchange for the member user redeeming a certain number of network points. However, the cost to the member merchant for this transaction (payable to the Incentive Network) may be greater than if the member merchant provided a 15% discount for the same number of network points redeemed by the user. With this unique pricing structure of the disclosed principles, not only are member merchants incentivized to lower their price-per-purchase by providing greater discounts, but member users are incentivized to make larger or more purchases due to increased discounts.

In other embodiments, redemptions may be displayed as individual amounts to correspond with each item that is network points-redeemable. In such embodiments, the member merchant may dictate what products or services for which network or merchant points are redeemable. The number of network points being redeemed for the provided discount may also be displayed. The disclosed principles may also be implemented with mobile devices, and accordingly the exemplary website 900 illustrated in FIG. 9 may be implemented through a mobile version of a website having all the features and advantages of the full website 900.

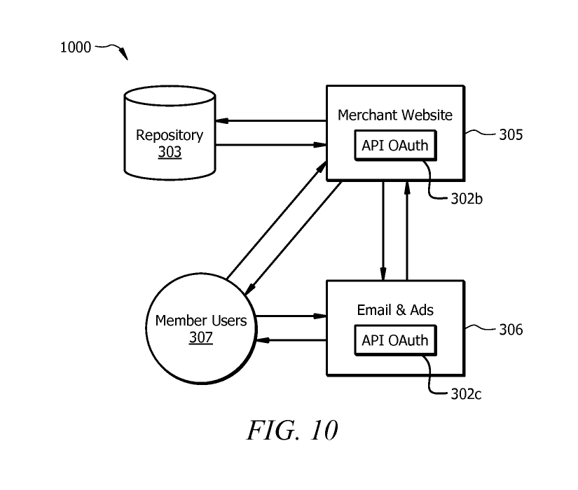

FIG. 10 illustrates a block diagram 1000 of one embodiment of the interaction of the repository 303 with member merchants, and in particular the member merchants' websites 305 (via the embedded API 302b), as well as the means by which the member merchants conduct their advertising campaigns to member users (e.g., via email and other advertisement media 306) which may also be embedded with the API 302c. Electronic ads may include banner ads, pop-up ads, search engine impressions, and textual direct-link ads; member merchants may also make advertisements that show up only on their website or storefront available to member users 307 from which to earn points.

As illustrated, member users 307 may access the member merchant website 305 directly. Member users 307 may also access the member merchants' website via email and other types of advertisements using, e.g., embedded links facilitated with the API. Emails that direct member users 307 to the member merchants' websites 305 may be distributed from the Integrated Incentive Network itself or from member merchants, or from entities implementing advertisement campaigns on behalf of member merchants. Advertisements associated with the Integrated Incentive Network may appear on non-Integrated Incentive Network-associated websites. In one embodiment, advertisements for one member merchant may appear on the websites of another member merchant, especially if the products of the two member merchants fall within a similar category or if the products are related in any way. Advertisements 306, as mentioned previously, may also appear directly on the member merchant's website 305 and offer additional incentives to member users 307 beyond the network points they may have already earned.

Member merchants' Integrated Incentive Network-based advertising campaign may also not be limited to electronic ads. Member merchants may use the tangible advertisements that may include an identifier, such as promotional code or QR code, where such identifier would allow member users 307 to have access to the advertised incentive and earn points at the same time by entering the code in an appropriate location. In some embodiments, short URLs or SMS short codes may also be used in such advertisements, and use of those short URLs or short codes to access member merchant websites 305 by a member user 307 could earn the member user 307 such points. In some embodiments, use of such unique identifiers, or the mere clicking or otherwise accessing of a member merchant's website 305 via a specific ad may cause specific Network-based rewards to be provide to existing or joining users, as compared to rewards obtained by direct navigation to the merchant's website 305.

In other embodiments, member merchants may still follow the conventional advertising model and display advertisements through search engines and impressions. Such advertisements may still fall within the scope of the Integrated Incentive Network; in such embodiments, the advertisement following the conventional advertising model may still use the process that the Integrated Incentive Network-associated advertisements use. In some embodiments, ads displayed along with or in such search results may even include a logo or emblem of the Incentive Network to indicate to member users the advantage of selecting those particular ads or search results.

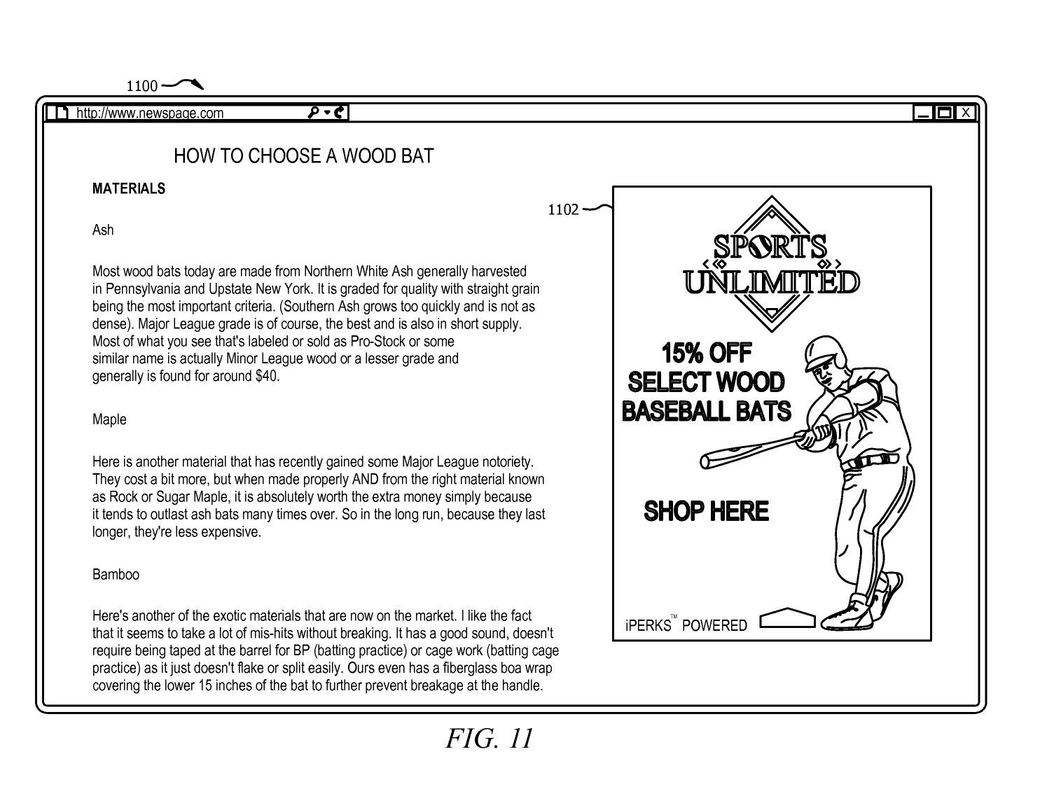

FIG. 11 is an exemplary embodiment of a screen shot of a computer network site 1100, such as an Internet website, that illustrates the disclosed principles in the context of electronic advertisements. An advertisement 1102 associated with the disclosed Integrated Incentive Network may be displayed on Integrated Incentive Network-associated website, or may be displayed on non-Integrated Incentive Network associated website. As illustrated, the associated advertisement 1102 may be labeled with a mark, emblem, or logo of the Integrated Incentive Network (e.g., “iPerk Powered”) to identify its association with the Integrated Incentive Network to member users or new users who may look to become members of the Network. In some embodiments, the Integrated Incentive Network-associated advertisement 1102 may be distributed through conventional advertising models, such as sponsored ads on search engine results. In other embodiments, the advertisement 1102 may appear as a direct textual link used in the text of the website 1100. Of course, any means by which such an associated ad 1102 may be distributed to members and potential users are also within the broad scope of the disclosed principles.

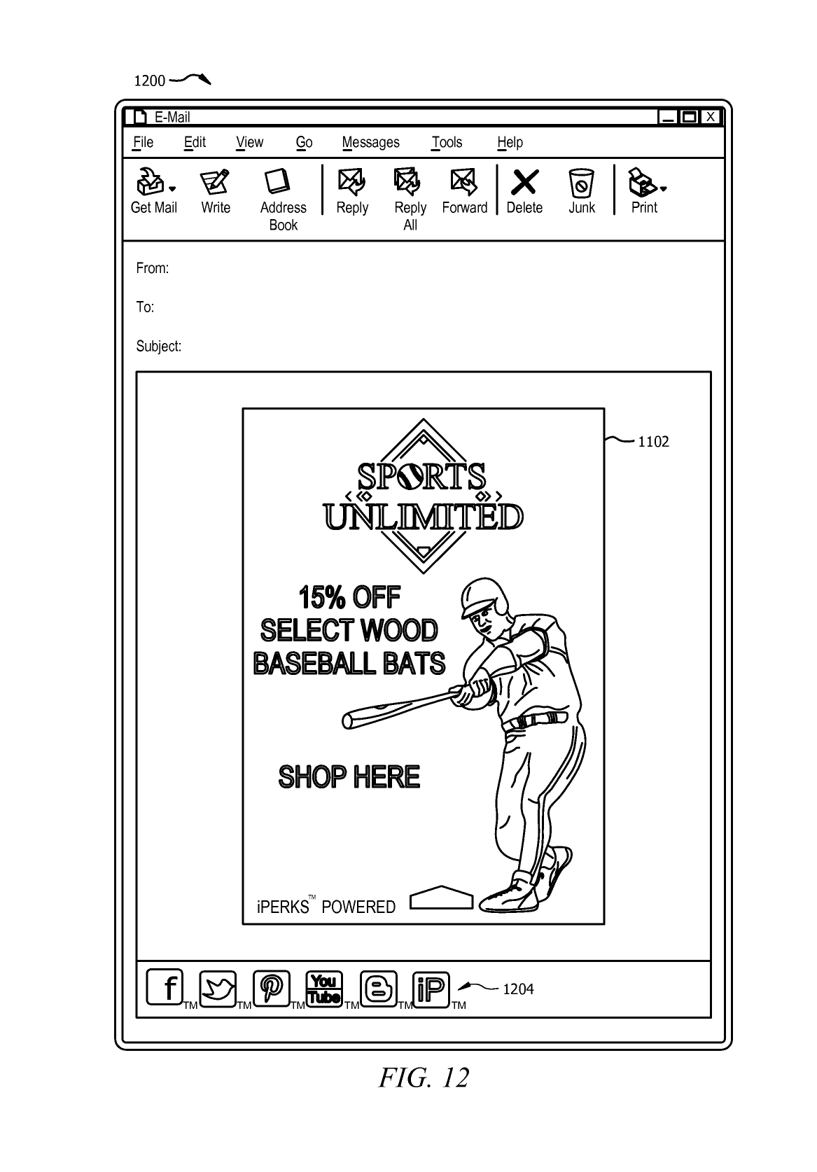

FIG. 12 is an exemplary embodiment of a screen shot of electronic mail (i.e., an email) 1200 that illustrates the disclosed principles in the context of an email. Integrated Incentive Network-associated email sent to member users may be sent from the Integrated Incentive Network or the member merchants. In other embodiments, an entity providing an advertising campaign on behalf of the Incentive Network or a member merchant may distribute the email 1200. In another embodiment, the emails sent from the Integrated Incentive Network may be sent on behalf of the member merchants.

Email sent to member users may involve discounts or rewards 1202 from one member merchant. In one embodiment, email sent to member users may involve incentives from member merchants that the member users may have visited in the past or for which member users may have expressed an interest. Alternatively, the incentives in the emails 1200 may be based on the mere browsing history of member users on member merchant sites. Emails sent to member users may also include a summary of the users' account information and points available for redemption. In one embodiment, the Integrated Incentive Network logo 1204 may be displayed on emails 1200 sent to member users to indicate that the sender of the email is associated with the Integrated Incentive Network.

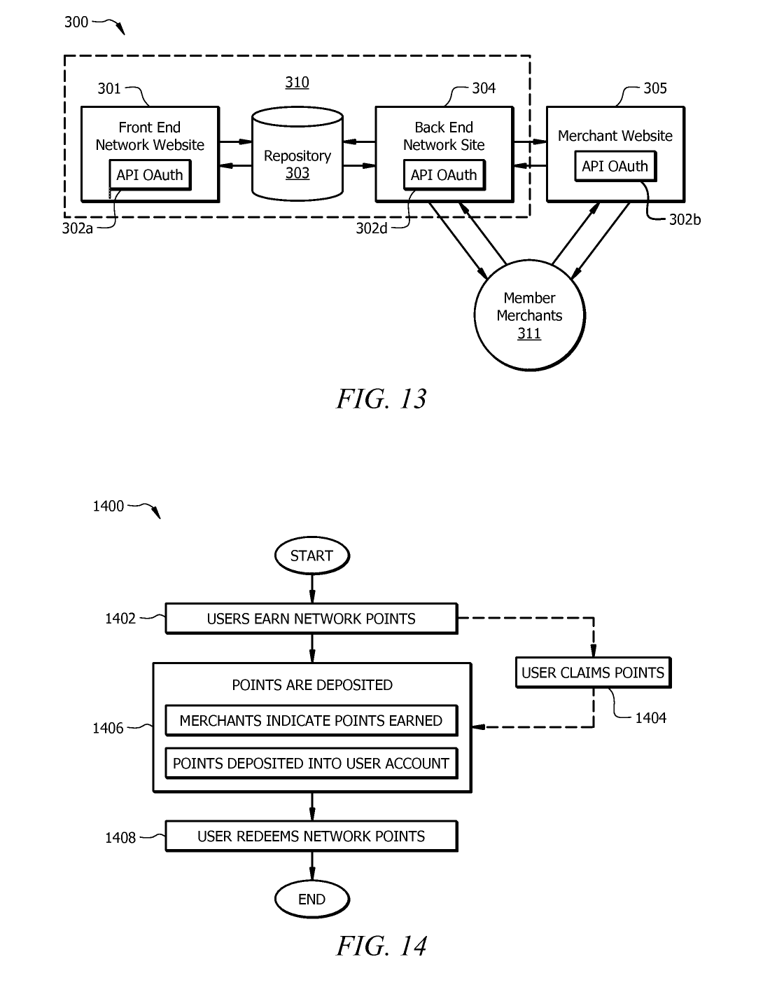

FIG. 13 is a block diagram 1300 of an embodiment of a portion of the Integrated Incentive Network 300 that involves facilitating the member merchants' interaction with the Integrated Incentive Network 300. Member merchants 311 may have access to the back end network site 304 and to their own website 305. The access between the merchant 311 and its website 305 is natural; the merchant 311 may be able to receive marketing information from visitors to the website 305. As illustrated, the central network controller 310 may comprise one or more of the back end network site 304 and repository 303. In other embodiments, the central network controller 310 may simply be in communication with either or both of these components directly or via one or more components, such as network servers.

In one embodiment, member merchants' website 305 may be interfaced with the repository 303 via the back end network site 304 or via an API embedded in a different member merchant interface. A member merchant 311 may be able to establish metrics for awarding and/or redeeming network points for member users; such metrics may also be stored in and retrieved from the repository 303. The Network-based repository 303 may allow the Integrated Incentive Network 300 to monitor the member merchants' 311 application of network points. The Integrated Incentive Network's API 302 (302a as implemented in the front end network website, and 302b as implemented in the member merchants' website 305) mentioned in FIG. 4 may be embedded in the back end network site 304 to automatically implement the rewards system of the disclosed Integrated Incentive Network 300. The back end network site 304 may allow member merchants 311 to manually disburse incentives or award gifts for various metrics (e.g., customer loyalty).

FIG. 14 sets forth a flow diagram 1400 of exemplary embodiments for earning and redeeming network points in an Integrated Incentive Network implemented in accordance with the disclosed principles. At a step 1402, member users may trigger a reward of network points by visiting member merchants' websites via direct URL navigation, or by selecting merchant links (email, electronic ads, or other types) through the Internet or other communications network, which they may have found via an advertisement, search engine, media display, or other means. Member users may earn network points by such visit, as well as for repeat visits. Moreover, member users may even earn additional points by making actual purchases at member merchants' websites.

Member merchants may also give away network points during events that they may hold to boost sales. Also, number, type, and value of awarded points can be different based on the type or amount of purchase, frequency of visits, or even which member merchant is visited. Other means of earning points with an Integrated Incentive Network as disclosed herein may also be provided, and the disclosed principles are not limited to any particular manner of earning points. In yet other embodiments, as mentioned above, not only may network points be earned for use at any member merchant's website (or in an Integrated Incentive Network exchange), member merchants may also choose to award their own dedicated, unique rewards points. In such embodiments, not only may member users redeem points, but member users may also be able to redeem dedicated points at specific member merchants' websites in an effort to increase repeat business with member users. At a step 1404, no matter how network or unique points are earned, such points are claimed for the member users.

As network points are earned, they are deposited into the repository. During this step 1406, member merchants may inform the Integrated Incentive Network that they have rewarded member users with points. The Integrated Incentive Network then may deposit the network points into the member users' account and update the member users' total. The association between the earned network points and the member merchants that disbursed/awarded the network points allows the Integrated Incentive Network to analyze consumer data and to assist the member users whenever they visit the front end network website. In one embodiment, member merchants may generate a code for member users to use to authorize the transaction before depositing the network points into the member users' account. For example, the member merchants' website may generate a code for member users to use on either the member merchants' website or the front end network website to authorize the transaction and claim the earned network points.

Upon earning the Network points, member users may redeem those points in various ways, at a step 1408. Importantly, points are not necessarily limited to redemption at the member merchants where the points were earned, and instead may be accumulated based on all of a member user's visits and/or purchases to any or all member merchants sites, and then redeemed partially or collectively at any of the member merchants' websites. For example, the member merchant's “shopping cart” or checkout procedure may be integrated with the Integrated Incentive Network via the API or other embedded code, as discussed above with reference to FIG. 9. Such an API may be configured to recognize when the consumer is a member user, as well as determining upon such authentication how many, if any, network points the member users may have that may be applied to the current purchase. Those points may have been previously acquired, or perhaps some or all were obtained during the member user's current visit to the member merchant's website. As a result, the disclosed principles may then provide for the redemption of some or all of the eligible points automatically when checking out at the member merchants' websites. In other embodiments, the member user may be prompted (i.e., be given the option) to apply his points, if desired, to the current purchase or to simply save them for another time. In still other embodiments, member users may be provided a unique redemption code to apply to an eligible purchase once they have amassed a predetermined number of network points. Of course, other variations for redeeming acquired network points are discussed above, and those and additional embodiments are all within the broad scope of the disclosed principles.

In embodiments involving member merchants disbursing and awarding their own dedicated or unique rewards points, the redemption step 1408 may again be automatic during a purchase from that merchant or may be elected by member users when desired. Whether or not redemption is automatic or elected by member users, member users may also be given the option to choose what percentage of points (network points or dedicated merchant points) to redeem.

In other embodiments, universal network points may simply be redeemable at a higher value when redeemed at the same member merchant's website at which they were originally earned, versus other member merchants, as discussed above. This higher redemption value will encourage users to redeem the network points at the member merchant that originated the points; however, such a technique is not required to practice the disclosed principles. In yet other embodiments, the value offered for network points may be different for one member merchant as compared to another member merchant. For example, one member merchant may offer a 10% discount for redeeming a given number of points, while a different member merchant may choose to offer a 20% discount for redeeming the same number of points. Again, other variations for redeeming Network Points may also be provided with the disclosed Integrated Incentive Network, and each such variation is within broad scope for the present disclosure. Additionally, some embodiments can allow member users to redeem network points (or unique member merchant points) in a manner different than discounts at particular member merchant sites. For example, member users may redeem network points for free shipping from the member merchant. In another embodiment, member merchants may allow member users to redeem network points on products or services not normally displayed or showcased on the merchants' storefront or website.

Based on the above, by providing rewards to its members in the form of network points, a rewards-based Integrated Incentive Network in accordance with the disclosed principles incentives member users to visit member merchant sites over non-member sites, as well as make purchases, and thus earn redeemable network points for discounts setup by member merchants or other rewards-based benefits. Through the disclosed rewards technique, member merchants increase advertising conversions by passing their savings in discounts to member users through network exchanged points. The disclosed Integrated Incentive Network keeps consumers coming back to visit member merchants' products and services available through each of the member merchants' websites (as compared to out-of-network merchants), rewards the member users for doing so, and increases the effective member merchant advertising efforts by incentivizing original and repeat organic traffic to member merchant websites and other storefronts, thus yielding increased sales at lower cost per acquisition.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Detailed Description” any claims issuing from the subject matter taught in the present disclosure should not be limited by the language chosen under this heading to describe the so-called field. Further, a description of any technology as background or conventional is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A private integrated incentive network for providing incentives for registered member users of the network to patronize sites of registered member merchants of the network, the integrated incentive network comprising:
a central network controller configured to track individual member user activity within the network on any member merchant site;
a user interface in communication with the central network controller, and configured to permit member users access to the central network controller;
a merchant interface in communication with the central incentive network, and configured to permit member merchants access to the central incentive network;
wherein the central network controller is further configured to award network points to a member user based on said member user visiting any member merchant site, and to facilitate redeeming by a member user of earned network points for value at any member merchant site; and
a repository in communication with each of the central network controller, the user interface, and the merchant interface, the repository configured to store member user profile information and member merchant profile information, and further configured to store information regarding network points earned and redeemed by member users.

2. An integrated incentive network in accordance with claim 1, wherein the central network controller is further configured to award additional network points to a member user as a result of a purchase made by said member user at a visited member merchant site.

3. An integrated incentive network in accordance with claim 1, wherein the central network controller is further configured to award unique merchant points that are unique to a particular member merchant to a member user based on that member user's visit to the particular member merchant's site, wherein said unique merchant points are redeemable only at a site associated with the particular member merchant.

4. An integrated incentive network in accordance with claim 3, wherein the central network controller is further configured to facilitate an exchange of network points for unique merchant points between members users via the member user interface.

5. An integrated incentive network in accordance with claim 3, wherein the central network controller is further configured to facilitate an exchange of network points for unique merchant points between a member user and the incentive network via the member user interface.

6. An integrated incentive network in accordance with claim 1, wherein a value of redeemed network points at one member merchant site is different than a value of redeemed network points at another member merchant site.

7. An integrated incentive network in accordance with claim 1, wherein the value of redeemed network points comprises a discounted dollar amount or a discounted percentage amount for a purchase at a member merchant site.

8. An integrated incentive network in accordance with claim 1, wherein the central network controller is configured to track the individual member user activity within the network using an application program interface configured to communicate with the central network controller in response to the user activity.

9. An integrated incentive network in accordance with claim 8, wherein the application program interface is embedded within one or more of a member merchant site, a member merchant advertisement posted on a non-member site, a member merchant email advertisement, or a member merchant advertisement posted on a social networking page of the member merchant.

10. An integrated incentive network in accordance with claim 8, wherein:
the user interface comprises a front end network site also comprising an embedded application program interface configured for communication with the central network controller; and
the merchant interface comprises a back end network site also comprising an embedded application program interface configured for communication with the central network controller.

11. An integrated incentive network in accordance with claim 8, wherein the application program interface is configured to facilitate authorization of the individual member user to the central network controller.

12. A method of providing incentives for registered member users of a private integrated incentive network to patronize sites of registered member merchants of the network, the method comprising:
storing member user profile information and member merchant profile information;
tracking individual member user activity within the network on any member merchant site;
awarding network points to a member user based on said member user visiting any member merchant site;
storing information regarding network points earned by member users;
facilitating redeeming by a member user of earned network points for value at any member merchant site;
storing information regarding network points redeemed by member users;

13. A method in accordance with claim 12, further comprising:
facilitating communication by a member user to his stored member user profile information, and to information regarding network points earned or redeemed by the member user; and
further comprising, facilitating communication by a member merchant to its stored member merchant profile information, and to information regarding network points earned or redeemed by member users based on tracked activity on the member merchant's site.

14. A method in accordance with claim 12, further comprising awarding additional network points to a member user as a result of a purchase made by said member user at a visited member merchant site.

15. A method in accordance with claim 12, further comprising awarding unique merchant points that are unique to a particular member merchant to a member user based on that member user's visit to the particular member merchant's site, wherein said unique merchant points are redeemable only at a site associated with the particular member merchant.

16. A method in accordance with claim 15, further comprising facilitating an exchange of network points for unique merchant points between members users via the member user interface.

17. A method in accordance with claim 15, further comprising facilitating an exchange of network points for unique merchant points between a member user and the incentive network via the member user interface.

18. A method in accordance with claim 12, wherein a value of redeemed network points at one member merchant site is different than a value of redeemed network points at another member merchant site.

19. A method in accordance with claim 12, wherein the value of redeemed network points comprises a discounted dollar amount or discounted percentage amount for a purchase at a member merchant site.

20. A method in accordance with claim 12, further comprising tracking individual member user activity within the network using an application program interface configured to communicate with a central network controller of the network in response to the user activity.

21. A method in accordance with claim 20, wherein the application program interface is embedded within one or more of a member merchant site, a member merchant advertisement posted on a non-member site, a member merchant email advertisement, or a member merchant advertisement posted on a social networking page of the member merchant.

22. A method in accordance with claim 20, further comprising facilitating authorization of the individual member user to the network.
